(19) United States
(12) Patent Application Publication
(10) Pub. No.: US 2017/0100617 A1
(43) Pub. Date: Apr. 13, 2017

(54) DEVICES, METHODS AND SYSTEMS FOR MONITORING WATER-BASED FIRE SPRINKLER SYSTEMS

(71) Applicant: Engineered Corrosion Solutions, LLC, St. Louis, MO (US)

(72) Inventors: Jeffrey T. KOCHELEK, Creve Coeur, MO (US); Adam H. HILTON, Chesterfield, MO (US)

(21) Appl. No.: 15/127,949

(22) PCT Filed: Mar. 6, 2015
(86) PCT No.: PCT/US2015/019267

§ 371 Date: Sep. 21, 2016

Related U.S. Application Data
(60) Provisional application No. 62/118,569, filed on Feb. 20, 2015.
(60) Provisional application No. 62/015,949, filed on Jun. 23, 2014.
(60) Provisional application No. 61/949,790, filed on Mar. 7, 2014.

(51) Int. Cl. A62C 37/50

(52) U.S. Cl. CPC A62C 37/50

(57) ABSTRACT

A method of monitoring a water-based fire sprinkler system having a piping network and one or more sprinkler components includes receiving one or more signals from the one or more sprinkler components, the one or more signals indicative of one or more parameters of the water-based fire sprinkler system, and displaying information representing the one or more parameters on a computer device having a display, sending one or more control signals to one or more of the sprinkler components, and/or sending one or more signals to another computer device. A monitoring device for a water-based fire sprinkler system includes at least one computer device configured to perform one or more of the methods disclosed herein. A sprinkler component for a water-based fire sprinkler system includes one or more detectors for detecting one or more parameters of a water-based fire sprinkler system and/or one or more field-adjustable settings, and a communication interface for outputting one or more signals indicative of the one or more detected parameters and/or for receiving one or more control signals from another device. The sprinkler component may be configured to adjust one or more field-adjustable settings in response to receiving one or more control signals. Additional methods, devices and systems are also disclosed.

### CROSS-REFERENCE TO RELATED APPLICATIONS

This application is a PCT International Application, and claims the benefit and priority of U.S. Provisional Application No. 61/949,790 filed Mar. 7, 2014, U.S. Provisional Application No. 62/015,949 filed Jun. 23, 2014, and U.S. Provisional Application No. 62/118,569 filed Feb. 20, 2015. The entire disclosures of each of the above applications are incorporated herein by reference.

### FIELD

The present disclosure relates to devices, methods and systems for monitoring water-based fire sprinkler systems.

### BACKGROUND

This section provides background information related to the present disclosure which is not necessarily prior art.

Water-based fire sprinkler systems are commonly used to protect buildings, property and people from fire. There are two main types of water-based fire sprinkler systems: wet pipe sprinkler systems and dry pipe sprinkler systems.

In wet pipe sprinkler systems, the piping network remains filled with water until the system is actuated. If exposed to freezing temperatures, the water in the piping network may freeze and cause the piping network to burst, resulting in substantial property damage and rendering the system inoperable. Therefore, wet pipe sprinkler systems are not well suited for applications involving freezing temperatures.

Dry pipe sprinkler systems can be used to protect unheated structures and other areas where the system is subject to freezing temperatures. Dry pipe systems (including preaction systems) are also used in locations where accidental water discharge from the system would be highly undesirable, such as museums, libraries and computer data centers. In dry pipe sprinkler systems, the piping network is filled with a pressurized gas (rather than water) until the system is actuated.

### SUMMARY

This section provides a general summary of the disclosure, and is not a comprehensive disclosure of its full scope or all of its features.

According to one aspect of the present disclosure, a method of monitoring a water-based fire sprinkler system is provided. The water-based fire sprinkler system includes a piping network and one or more sprinkler components. The method includes receiving one or more signals from the one or more sprinkler components, the one or more signals indicative of one or more parameters of the water-based fire sprinkler system, and displaying information representing the one or more parameters on a computer device having a display, sending one or more control signals to one or more of the sprinkler components, and/or sending one or more signals to another computer device.

According to another aspect of the present disclosure, a monitoring device for a water-based fire sprinkler system includes at least one computer device configured to perform any one or more of the methods disclosed herein.

According to a further aspect of the present disclosure, a sprinkler component for a water-based fire sprinkler system includes one or more detectors for detecting one or more parameters of a water-based fire sprinkler system, and a communication interface for outputting one or more signals indicative of the one or more detected parameters.

According to another aspect of the present disclosure, a sprinkler component for a water-based fire sprinkler system includes one or more field-adjustable settings, and a communication interface for receiving one or more control signals from another device, the sprinkler component configured to adjust the one or more field-adjustable settings in response to receiving the one or more control signals.

According to yet another aspect of the present disclosure, a water-based fire sprinkler system includes a piping network and one or more of the sprinkler components disclosed herein.

According to still another aspect of the present disclosure, a system includes a first one of the fire sprinkler systems disclosed herein, a second one of the fire sprinkler systems disclosed herein, one of the monitoring devices disclosed herein, and a communication network connecting the monitoring device to the first fire sprinkler system and the second fire sprinkler system, the monitoring device configured to receive signal(s) from the first fire sprinkler system indicative of one or more parameters of the first fire sprinkler system, and signal(s) from the second fire sprinkler system indicative of one or more parameters of the second fire sprinkler system.

According to a further aspect of the present disclosure, an auxiliary low point drain for a water-based fire sprinkler system includes a chamber for receiving water from a piping network of the fire sprinkler system, a first valve for controlling passage of water from the piping network to an interior of the chamber, a second valve for controlling passage of water from the interior of the chamber to an external environment, and a communication interface for sending data to and/or receiving data from a remote device via a communication network.

According to still another aspect of the present disclosure, a method of monitoring an auxiliary low point drain of a water-based fire sprinkler system is disclosed. The method includes accessing weather data corresponding to a location of the auxiliary low point drain, determining whether the accessed weather data is forecasting a temperature below a threshold temperature at the location of the auxiliary low point drain, and in response to determining the accessed weather data is forecasting a temperature below a threshold temperature at the location of the auxiliary low point drain, sending an alert signal to a computer device associated with the auxiliary low point drain and/or sending one or more control signals to the auxiliary low point drain via a communication network.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow diagram of a method of monitoring a water-based fire sprinkler system according to one aspect of the present disclosure.

FIG. 2 is a block diagram of a sprinkler component for a water-based fire sprinkler system according to one example embodiment of this disclosure.

FIG. 3 is a block diagram of a sprinkler component having a communication interface for receiving control signal(s) from another device according to another example embodiment.

FIG. 4 is a block diagram of a fire sprinkler system having a monitoring device according to another example embodiment of the present disclosure.

FIG. 5 is a block diagram of a fire sprinkler system similar to the system of FIG. 4, where the monitoring device is integrated with one of the sprinkler components.

FIG. 6 is a block diagram of a fire sprinkler system having an in-facility communicator in addition to a monitoring device.

FIG. 7 is a block diagram of fire sprinkler system similar to the system of FIG. 6, where the in-facility communicator is integrated with one of the sprinkler components.

FIG. 8 is a system diagram illustrating multiple fire sprinkler systems coupled to a monitoring device via a communication network.

FIG. 9 is a block diagram of a dry pipe fire sprinkler system including a monitoring device according to another example embodiment of this disclosure.

FIG. 10 is a block diagram of a wet pipe fire sprinkler system including a monitoring device according to yet another example embodiment.

FIG. 11 is a perspective view of an in-line corrosion detector having a pressure detector according to another example embodiment.

FIG. 12 is a front view of a wet pipe vent having a pressure detector according to another example embodiment.

FIG. 13 is a perspective view of a wet pipe vent similar to FIG. 12 and including a pressure detector housing.

FIG. 14 is a front view of a wet pipe vent having a pressure detector according to yet another example embodiment.

FIG. 15 is a front view of a wet pipe vent having a conductance detector according to still another example embodiment.

FIG. 16 is a block diagram of a dry pipe fire sprinkler system including an in-facility communicator according to another example embodiment.

FIG. 17 is a block diagram of a wet pipe fire sprinkler system having an in-facility communicator according to another example embodiment.

FIG. 18 is an isometric view illustrating multiple zones of a wet pipe fire sprinkler system according to another example embodiment.

FIG. 19 is a block diagram illustrating one example implementation of an in-facility communicator and a monitoring device.

Corresponding reference numerals indicate corresponding parts throughout the several views of the drawings.

### DETAILED DESCRIPTION

Example embodiments will now be described more fully with reference to the accompanying drawings.

Example embodiments are provided so this disclosure will be thorough, and will fully convey the scope to those who are skilled in the art. Numerous specific details are set forth such as examples of specific components, devices, systems and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

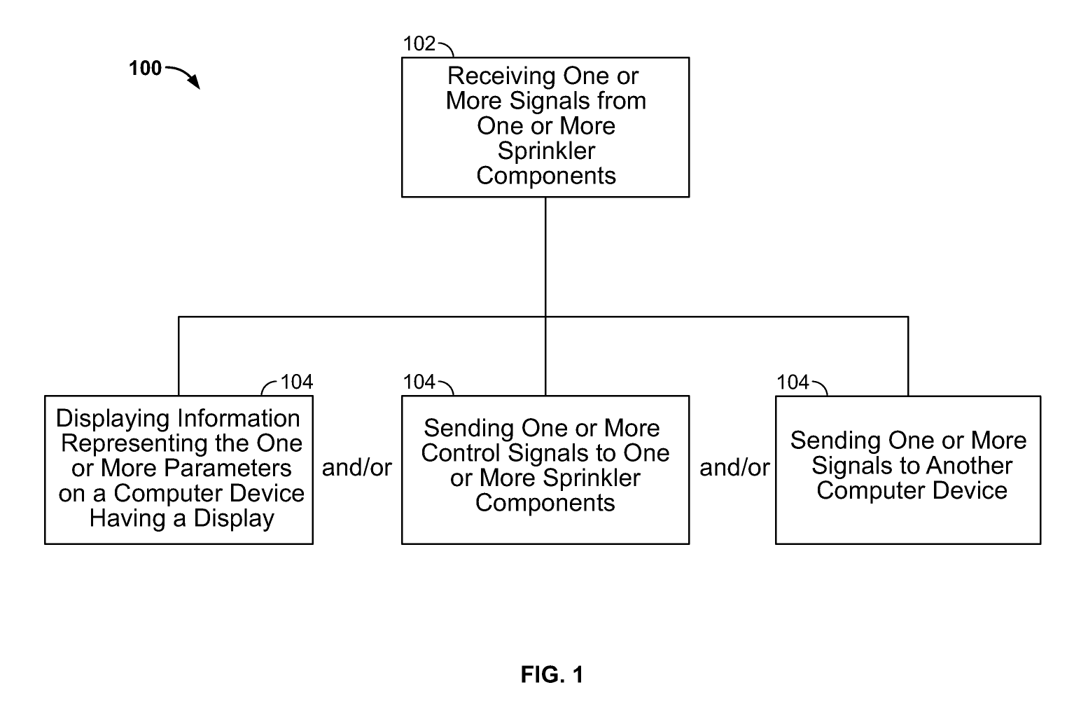

A method of monitoring a water-based fire sprinkler system according to one example embodiment of the present disclosure is illustrated in FIG. 1 and indicated generally by reference number 100. The water-based fire sprinkler system includes a piping network (typically including black iron and/or galvanized steel piping) and one or more sprinkler components. As shown in FIG. 1, the method 100 includes (at 102) receiving one or more signals from the one or more sprinkler components. The one or more signals are indicative of one or more parameters of the water-based fire sprinkler system. The method 100 further includes (at 104) displaying information representing the one or more parameters on a computer device having a display, sending one or more control signals to one or more of sprinkler components, and/or sending one or more signals to another computer device.

The one or more signals may be received in any suitable manner, including via wired and/or wireless communication network(s) using one or more communication protocols. The signal(s) may be received continuously, intermittently (e.g. in response to a state change in the sprinkler system, at regular intervals, in response to user input, etc.), or in another suitable manner. Further, the signal(s) may be received from the sprinkler component(s) directly or via intermediary device(s).

The sprinkler components may include, for example, a nitrogen generator, a nitrogen storage system (e.g., including one or more nitrogen cylinders), an air compressor, a gas analyzer, a corrosion detector, a dry pipe vent, a wet pipe vent, a water pump, an auxiliary low point drain (also referred to as a “drum drip”), etc.

The one or more parameters indicated by the received signal(s) may include pressure, temperature, oxygen level, device operating status, device operating history, elapsed time (e.g., the duration of time since the valves of an auxiliary low point drain were last cycled), presence of power, electric current, voltage, conductance, gas flow, gas purity, valve position, oil level, presence of water, status of a field-adjustable setting, geographic location of a sprinkler component and/or system, the type and/or ID of a sprinkler component, etc.

As noted above, the method 100 may include displaying one or more parameters on a computer device having a display. Some examples of suitable computer devices include personal computers, computer servers, tablet computers, smartphones, computer-based building management systems, computer-based fire alarm control panels, etc. The display may be any suitable electronic visual display including, for example, a computer monitor, a touchscreen, a smartphone display, etc.

Additionally, or alternatively, the method 100 may include sending one or more control signals to one or more of the sprinkler components. Such control signal(s) may be sent via the same communication network(s) employed for receiving signals and/or via other communication network(s). Further, the control signal(s) may be sent to the same sprinkler component(s) from which the parameter-indicating signals are received and/or to other sprinkler component(s).

The control signal(s) may be configured to adjust operation of one or more of the sprinkler components. For example, a particular control signal may encode a command that, when received by a sprinkler component, will cause the sprinkler component to adjust its operation in some manner. Some examples of commands that may be represented by the control signal(s) include an open valve command, a close valve command, a cycle valves command, a reset command, a power on command, a power off command, a gas purity setting command, a pressure setting command, an indicator on/off command, etc.

The control signal(s) may be sent to one or more of the sprinkler components in response to user input. For example, upon receiving a signal indicating a particular sprinkler component of a fire sprinkler system is not operating properly, a user may provide input—via the user interface of a computer device—that initiates the sending of a control signal representing a power off command for the sprinkler component in question. Some examples of suitable user interfaces include keyboards, mouses, touchscreens, microphones, etc.

Additionally, or alternatively, the control signal(s) may be sent to one or more of the sprinkler components automatically, in response to receiving the parameter-indicating signal(s). For example, the control signal(s) may be sent automatically by a suitably programmed computer device executing computer instructions and/or algorithms stored in non-transitory memory.

In addition to (or instead of) displaying information and/or sending control signal(s), the method 100 may include sending signal(s) to another computer device (e.g., a computer device physically remote from the device sending the signal(s)). The signal(s) sent to the other computer device (e.g., analog and/or digital signals) may provide information about one or more parameters of the sprinkler system. Additionally, or alternatively, these signal(s) may include alert signal(s), such as information-bearing signal(s) configured to trigger an audible and/or visual alert on another computer device, such as a personal computer, smartphone, pager, etc. The alert signal(s) may also take the form of audio messages (e.g., prerecorded or computer-generated voice messages).

The method 100 may also include accessing weather data (e.g., from an online weather database) for a geographic location where the one or more sprinkler components are located. In that event, the method 100 may include sending one or more alert signal(s) to one or more computer devices in response to accessing weather data forecasting a temperature for the geographic location below a threshold temperature. For example, if the weather data indicates a potential freezing condition at the location of a sprinkler component or system (e.g., the forecasted temperature is below, e.g., forty degrees, thirty-five degrees, or thirty-two degrees Fahrenheit), freeze alert signal(s) may be sent to one or more computer devices, such as computer devices assigned to operators responsible for the applicable sprinkler component(s) and/or system(s). The freeze alert signal(s) may be used to prompt operator(s) to, for example, cycle the valves of auxiliary low point drain(s) (i.e., to remove water from the drains that may otherwise freeze and cause damage) and/or take other appropriate action(s) in response to the predicted freezing or near-freezing temperature.

The method 100 illustrated in FIG. 1 is advantageously useful for monitoring (on-site and/or remotely) the operating status and/or performance of water-based fire sprinkler systems, including but not limited to parameters related to corrosion activity and/or the propensity for corrosion in the piping networks of such systems, so that appropriate action can be taken as and when necessary to ensure proper system operation and longevity while avoiding unnecessary maintenance costs and system downtime. For example, the method 100 may include processing one or more parameters to determine a supervisory gas leak rate in a fire sprinkler system, a frequency of compressed gas injection in a fire sprinkler system, a runtime of a compressed gas injection device in a fire sprinkler system, actuation of a fire sprinkler system, draining of an auxiliary low point drain in a fire sprinkler system, corrosion activity in a fire sprinkler system (e.g., based on temperature(s), pressure(s), amounts and/or frequency of oxygen introduction or exposure in the system), etc.

According to another aspect of the present disclosure, a monitoring device for a water-based fire sprinkler system includes at least one computer device configured to perform one or more of the methods disclosed herein. Such computer device may or may not include a display depending, for example, on whether the method to be performed by the computer device includes displaying information to a user. If the method to be performed by the computer device is limited to sending control signal(s) to sprinkler component(s) and/or sending signal(s) to other computer device(s), a display is not necessarily required. In some embodiments, the computer device includes a display and a user interface.

The computer device may be configured to perform the method(s) using any suitable hardware and/or software. For example, the computer device may include one or more processors for executing instructions stored in onboard and/or offboard memory (i.e., non-transitory computer-readable media). The instructions can be written as desired, in a wide variety of ways and using any suitable programming language(s), to cause the computer device to perform the method(s). Some examples of suitable processors include microprocessors, digital signal processors (DSPs), field-programmable gate arrays (FPGAs), programmable logic controllers (PLCs), etc. Some examples of suitable programming languages include BASIC, C, State Logic, hardware description language (HDL), etc.

The monitoring device (including the computer device described above) may be located on-site or off-site with respect to any particular fire sprinkler system.

Further, the monitoring device may be a standalone device, or may be integrated with a building management system (BMS), a fire alarm control panel (FACP), and/or one more sprinkler components of a particular fire sprinkler system. For example, the monitoring device may be integrated with a nitrogen generator, where the nitrogen generator is configured (i.e., via hardware and/or software stored in non-transitory memory) to perform one or more of the methods disclosed herein.

According to another aspect of the present disclosure, a method of monitoring a water-based fire sprinkler system having an auxiliary low point drain includes accessing weather data corresponding to a location of the auxiliary low point drain, determining whether the accessed weather data is forecasting a temperature below a threshold temperature at the location of the auxiliary low point drain and, in response to determining the accessed weather data is forecasting a temperature below a threshold temperature at the location of the auxiliary low point drain, sending an alert signal to a computer device associated with the auxiliary low point drain and/or sending one or more control signals to the auxiliary low point drain via a communication network. The weather data may be accessed from any suitable source, including from an online weather database, a weather data subscription service, etc.

Optionally, the method may include receiving data from the auxiliary low point drain via a communication interface. The received data may represent one or more parameters of the auxiliary low point drain including, for example, the location of the auxiliary low point drain, a pressure (e.g., in a collection chamber of the auxiliary low point drain), a temperature internal or external to the auxiliary low point drain (e.g., the ambient temperature at the drain's location), a presence or level of water (e.g., in a collection chamber), an amount of time since the auxiliary low point drain was last cycled, a type and/or ID of the auxiliary low point drain, etc.

Additionally, the method may include storing the location of the auxiliary low point drain (e.g., in a monitoring device associated with the fire sprinkler system). In that event, the weather data may be accessed using the stored location. Prior to storing, the location data may be input into the monitoring device by a user, received from the auxiliary low point drain via a communication network, etc. The location data may identify the location of the auxiliary low point drain in any suitable manner including, e.g., by address, city and/or state, zip code, GPS coordinates, etc.

The method may also (or instead) include determining whether one or more valves of the auxiliary low point drain have been cycled. For example, a typical auxiliary low point drain for a dry pipe system includes a chamber for receiving water from the piping network of the fire sprinkler system, an upper valve for controlling passage of water from the piping network to an interior of the chamber, and a lower valve for controlling passage of water from the interior of the chamber to an external environment (e.g., external to the fire sprinkler system and the auxiliary low point drain). During normal operation, the upper valve is open to permit small amounts of water to drain from the piping network into the chamber, while the lower valve is closed to prevent the draining of water from the chamber, and to prevent pressurized gas (also referred to as “supervisory gas”) from escaping the piping network. From time to time, and ideally prior to an anticipated freeze event, the upper and lower valves are cycled by first closing the upper valve, and then opening the lower valve. This allows water collected in the chamber to drain from the chamber to the external environment without allowing an appreciable amount of supervisory gas pressure to escape the piping network of the dry pipe system. After the water has drained from the chamber, the lower valve is closed, and then the upper valve is opened to once again permit small amounts of water in the piping network to drain into and collect in the chamber. Thus, by determining whether the upper and lower valves have been cycled as described above (or cycled in another suitable manner), the method can be used to determine whether any water is present in the chamber and/or whether the valve(s) need to be cycled again (or for the first time) before an anticipated freeze event.

Whether the valve(s) have been cycled can be determined based on data received from the auxiliary low point drain. For example, whether the valve(s) have been cycled may be determined from received data representing a pressure internal to the chamber (which may drop to ambient pressure while the chamber is draining with the upper valve closed and the lower valve open, and then return to system pressure when the lower valve is closed and the upper valve is opened), position(s) of the upper and lower valves (e.g., as detected by valve position detector(s) in the auxiliary low point drain), the presence or level of water in the chamber (e.g., as detected by a liquid detector in the auxiliary low point drain), etc.

If the method includes sending an alert signal to a computer device associated with the auxiliary low point drain, the computer device is preferably one assigned to an operator responsible for the auxiliary low point drain. Upon receiving the alert signal via the assigned computer device, the operator will preferably cycle the valve(s) of the auxiliary low point drain as necessary to remove any water collected in the chamber before the drain is subjected to freezing temperatures.

The method may also include determining whether the valve(s) of the auxiliary low point drain have been cycled within a defined duration of time after sending an alert signal to the computer device and, if not, sending one or more additional (preferably escalating) alert signals to the same computer device (e.g., assigned to the responsible operator) and/or to another computer device (e.g., assigned to the operator's supervisor).

Further, the method may optionally include sending one or more control signals to the auxiliary low point drain via a communication network. For example, if the auxiliary low point drain includes remotely controllable valve(s) such as solenoid valve(s), and/or remotely controllable indicator(s), the control signal(s) may cause the auxiliary low point drain to cycle one or more valves as necessary to drain water from its collection chamber, activate one or more visual and/or audible indicators to indicate to an operator that the valve(s) should be cycled to drain water from the collection chamber, etc.

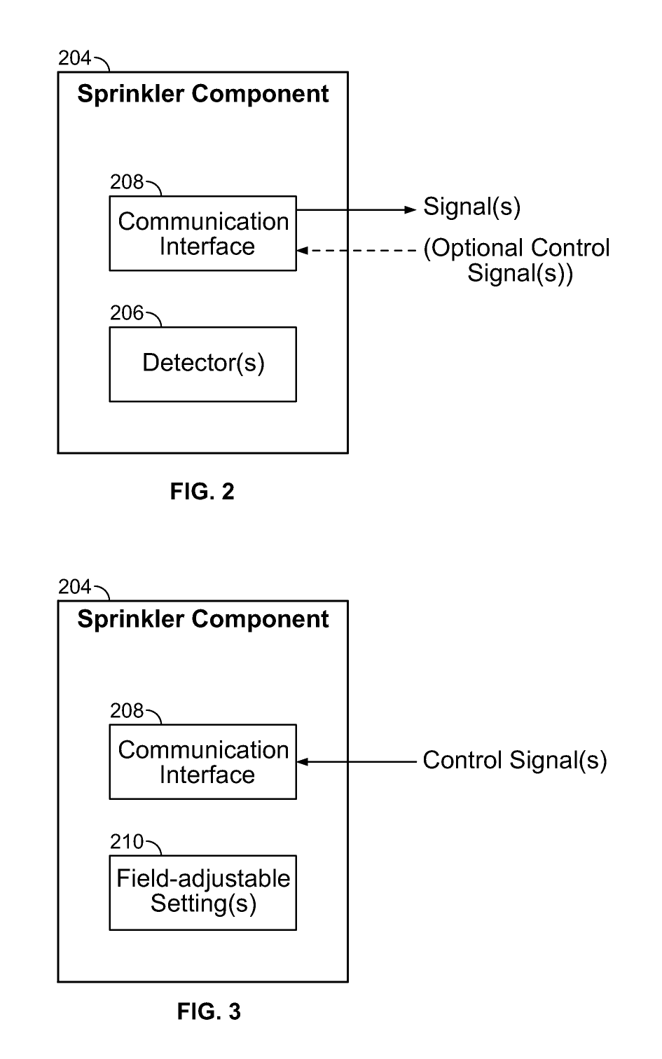

FIG. 2 illustrates a sprinkler component 204 for a water-based fire sprinkler system according to another aspect of the present disclosure. As shown in FIG. 2, the sprinkler component 204 includes one or more detectors 206 for detecting (i.e., measuring, sensing, etc.) one or more parameters of a water-based fire sprinkler system. The sprinkler component 204 further includes a communication interface 208 for outputting one or more signals indicative of the one or more detected parameters.

The detector(s) 206 may include, for example, a current sensor (such as a current sensing relay, an induced current detector, an ammeter, a current sense resistor, etc.), an oxygen sensor, a temperature sensor (e.g., a thermocouple), a pressure transducer (e.g., a pressure sensor or switch), a timer (e.g., an hour meter), a flow meter, a filter manometer, a valve position sensor, a low oil switch, a liquid or water detector, a geographic location detector (e.g., a global positioning system (GPS) receiver), and any other type of detector(s) for detecting parameter(s) of interest in a fire sprinkler system.

The liquid detector (if employed) may utilize, e.g., electrical conductivity detection (e.g., by inducing a voltage between two electrodes that will produce a current flow therebetween when water is present), sonar detection (e.g., by inducing a known sound wave into a space, and measuring a reflected sound for comparison to known benchmark(s) associated with the presence and/or absence of water), optical detection (e.g., by inducing a known light wave into a space and measuring the light with a collection device, where the presence of water will cause some of the light to diffuse, thus creating a measurable difference at the collection device indicating the presence of water), ionization detection (e.g., using an ion emitter and collector, where the presence of water will block the ion path and change the reading at the collector) and/or other suitable detector(s).

Accordingly, the detected parameters may include, for example, pressure, temperature, oxygen level, device operating status, elapsed time, presence of power, electric current, voltage, conductance, gas flow, gas purity, valve position, oil level, presence and/or amount of water, geographic location, status of a field-adjustable setting, etc.

Additionally, or alternatively, the sprinkler component may output signals indicative of its geographic location (e.g., as stored in memory at the factory, as input by a user, etc.), signals identifying the type of sprinkler component (e.g., whether the component is a nitrogen generator, a wet vent, a dry vent, an auxiliary low point drain, etc. and/or its year, make and/or model), and/or signals representing an identifier (ID) of the sprinkler component (e.g., a serial number or other unique or non-unique identifier).

The geographic location of the sprinkler component 204 may be detected, stored and/or input by a user in any suitable form including, for example, as a street address, city and state, zip code, GPS coordinates, etc.

The design and complexity of the communication interface 208 may vary for any given implementation. For example, the communication interface 208 may comprise a single wire, electrical connector, relay, etc. for providing a signal generated (or initiated) by a detector 206 to another device, such as one of the monitoring devices described herein. Alternatively, the communication interface 208 may include multiple wires, electrical connectors, a processor and/or a transmitter for generating and transmitting (via wires or wirelessly) signals indicative of the detected parameter(s). The processor (if employed) may be configured (e.g., via computer-executable programming instructions stored in non-transitory memory) to process signal(s) from the detector(s) 206 and/or to generate the output signal(s). In view of the above and the additional examples below, it should be understood the configuration of the communication interface 208 can take many different forms and is not limited to the specific examples disclosed herein.

The sprinkler component 204 may also be configured to receive via the communication interface 208 one or more control signals from another device (e.g., a monitoring device), and adjust its operation in response to the control signal(s). Accordingly, the communication interface 208 may include electrical connector(s) and/or a receiver, antenna, etc. for receiving control signal(s) from another device via wires and/or wirelessly.

Further, the sprinkler component 204 may include one or more field-adjustable settings, such as the position of a valve (such as a solenoid valve) or switch (such as an electromagnetic or electronic relay), a gas purity setting, a pressure setting, the state of a visual or audible indicator, etc. In that event, the sprinkler component 204 may be configured to adjust its field-adjustable setting(s) in response to control signal(s) representing one or more particular commands, such as an open valve command, a close valve command, a cycle valves command, a reset command, a power on command, a power off command, a gas purity setting command, a pressure setting command, etc.

Additionally, the sprinkler component 204 may include a display (e.g., an analog or digital display) for displaying parameters of interest, including any of the various parameters disclosed herein.

FIG. 3 illustrates an example sprinkler component 204 having a communication interface 208 for receiving control signal(s) from another device and field-adjustable setting(s) 210. The sprinkler component 204 of FIG. 3 is configured to adjust the one-more field-adjustable setting(s) 210 in response to receiving the control signal(s). The sprinkler component 204 of FIG. 3 may also include one or more detectors, and may be configured to output signal(s) indicative of various parameters, including its operating condition or status, geographic location, component type and/or ID, etc.

The example sprinkler components 204 shown in FIGS. 2 and 3 may include and/or be coupled to any suitable AC and/or DC power source(s) including, for example, a utility grid, AC-DC converters, batteries, uninterruptible power sources (UPSs), etc.

The example sprinkler components 204 shown in FIGS. 2 and 3 may be, for example, a nitrogen generator, a nitrogen storage system, an air compressor, a gas analyzer, a corrosion detector, an auxiliary low point drain, a dry pipe vent, a wet pipe vent and/or a water pump, etc. In one particular embodiment, the sprinkler component 204 is an air compressor having a compressor motor, a communication interface 208, and a relay (e.g., a field-adjustable component) for powering the compressor motor on and off in response to control signal(s) received via the communication interface from another device (such as one of the monitoring devices described herein).

Each sprinkler component 204 is preferably adapted for coupling to a water-based fire sprinkler system via pipe fittings, electrical cables, and/or other suitable means.

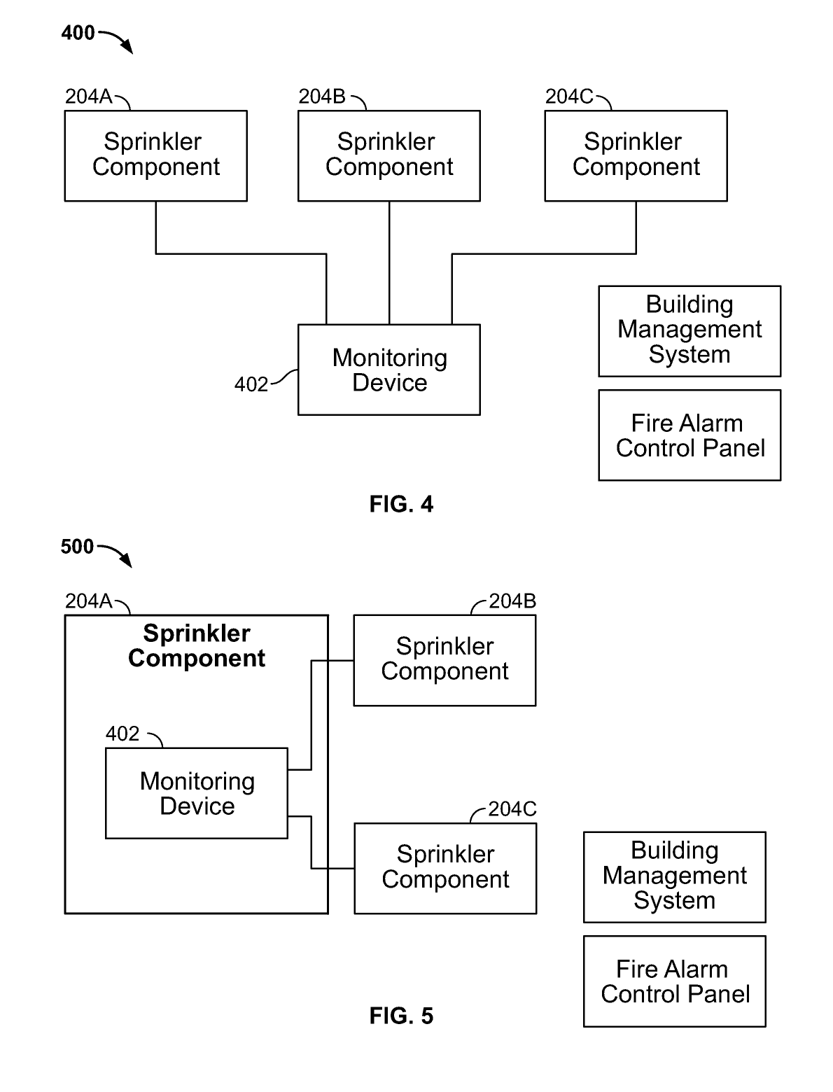

FIG. 4 illustrates a water-based fire sprinkler system 400 according to another example embodiment. The sprinkler system 400 includes a monitoring device 402 (examples of which are described above and below) and several sprinkler components 204A, 204B, 204C (examples of which are also described above and below).

In the system 400 of FIG. 4, the monitoring device 402 is connected in communication with the sprinkler components 204A-204C via a wired and/or wireless communication network for receiving signals from the sprinkler components 204A-204C indicative of parameters of the fire sprinkler system 400. As explained above, the monitoring device 402 may also be configured to send control signal(s) to one or more of the sprinkler components 204A-204C, and the sprinkler components 204A-204C may be configured to adjust their operation in response to the control signal(s).

Also shown in FIG. 4 is a building management system (BMS) and a fire alarm control panel (FACP). While the monitoring device 402 is shown external to the BMS and the FACP in the example of FIG. 4, the monitoring device 402 may be integrated with the BMS or FACP in other embodiments. Further, the monitoring device 402 may be configured to send signal(s) to the BMS and/or FACP indicative of one or more parameters of the sprinkler system 400.

Although three sprinkler components 204A-204C are shown in FIG. 4, it should be understood that more or less sprinkler components may be employed in any given implementation of these teachings. Further, the sprinkler components 204A-204C may be the same or different types of components. As just one example, component 204A may be a nitrogen generator, component 204B may be a corrosion detector, and component 204C may be a vent and/or gas analyzer.

FIG. 5 illustrates a water-based fire sprinkler system 500 according to another example embodiment. The system 500 of FIG. 5 is similar to the system 400 of FIG. 4, except the monitoring device 402 in the system 500 is integrated with one of the sprinkler components 204A.

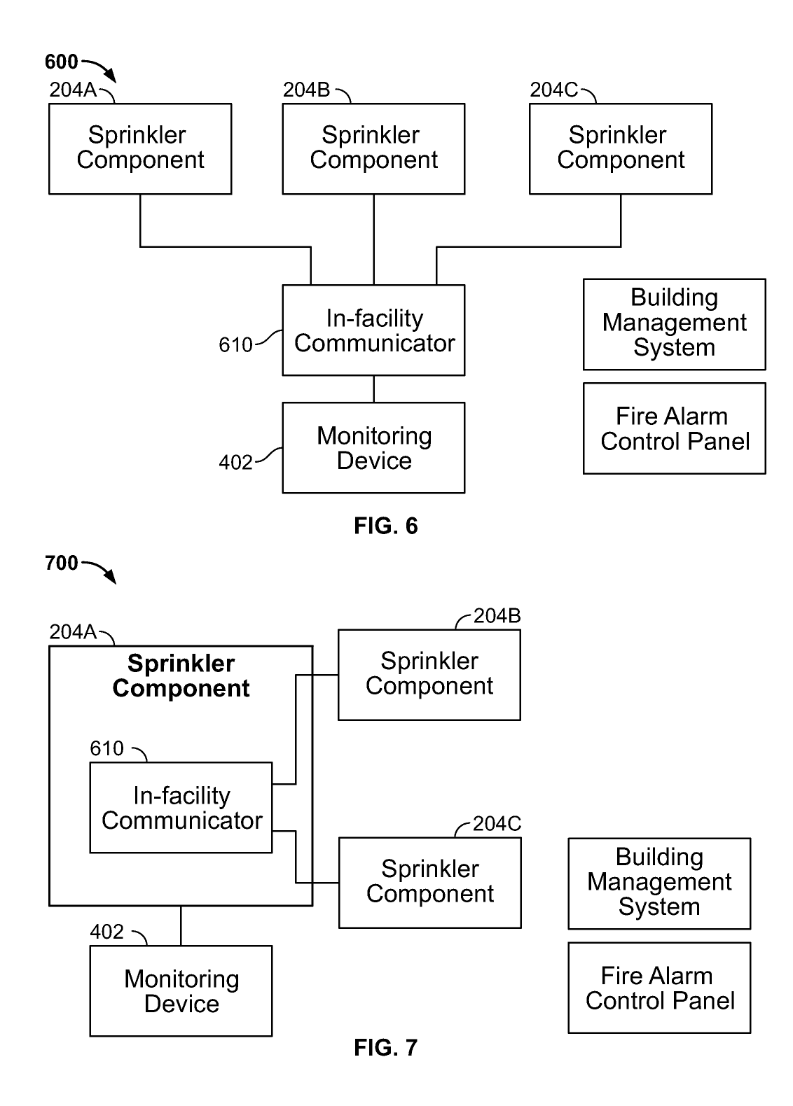

FIG. 6 illustrates a water-based fire sprinkler system 600 according to yet another example embodiment. The system 600 is similar to the system 400 shown in FIG. 4, except the system 600 of FIG. 6 includes an in-facility communicator 610 connected in communication with the monitoring device 402 and the sprinkler components 204A-204C. Therefore, rather than (or in addition to) outputting signals to the monitoring device 402, the sprinkler components 204A-204C output signals to the in-facility communicator 610. The in-facility communicator 610 may be configured to send corresponding signals (e.g., indicative of parameters in the system 600) to the monitoring device 402. The in-facility communicator 610 may also be configured to send signals to the BMS and/or FACP. The monitoring device 402 may be configured to send signals to one or more of the sprinkler components 204A-204C (and/or the BMS and/or FACP), either directly or via the in-facility communicator 610.

In addition to receiving signals from the sprinkler components 204A-204C and sending signals to the monitoring device 402, the various in-facility communicators 610 described herein may be configured to perform any of the methods disclosed herein. Thus, a particular in-facility communicator 610 may provide more, less or the same functionality as a monitoring device 402. This may be desirable where, for example, the in-facility communicator 610 is located on-site with the sprinkler components 204A-204C and the monitoring device 402 is located off-site relative to the sprinkler components 204A-204C. As should be apparent, the in-facility communicator 610 may include a computer device, such as a computer device of the type described herein in connection with the monitoring device 402. In many embodiments, the in-facility communicator 610 may also be considered a monitoring device as described herein.

Additionally, the in-facility communicator 610 and/or the monitoring device 402 may be configured to log data representing one or more parameters of the fire sprinkler system 600 (as well as other fire sprinkler systems). Further, the in-facility communicator 610 and/or the monitoring device 402 may be configured to permit authorized users to remotely access (e.g., via the Internet) the logged data using a suitable computer device. The in-facility communicator 610 and/or the monitoring device 402 may also be configured to send alert signals (such as email, text, voice or other alerts) in response to receiving specific (or any) data regarding one or more detected parameters in a particular sprinkler system.

Although the monitoring device 402 and the in-facility communicator 610 are shown external to the BMS and the FACP in the example of FIG. 6, the monitoring device 402 and/or the in-facility communicator 610 may be integrated with the BMS or the FACP in other embodiments.

FIG. 7 illustrates a water-based fire sprinkler system 700 according to still another example embodiment. The system 700 of FIG. 7 is similar to the system 600 of FIG. 6, except the in-facility communicator 610 is integrated with one of the sprinkler components 204A.

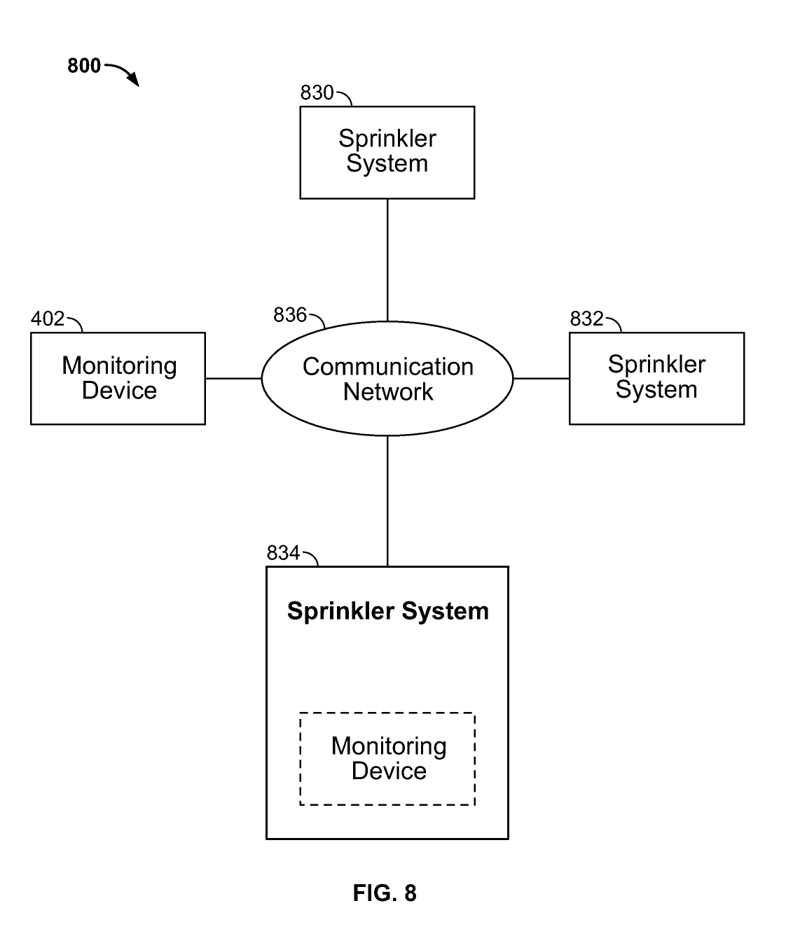

FIG. 8 illustrates a system 800 according to another example embodiment of this disclosure. As shown in FIG. 8, the system 800 includes several fire sprinkler systems 830, 832, 834 connected to a monitoring device 402 via a communication network 836. The monitoring device 402 may be configured to perform any of the methods disclosed herein, and each fire sprinkler system 830-834 may be configured like any of the fire sprinkler systems disclosed herein. Accordingly, the monitoring device 402 may receive signals from one or more sprinkler components in each of the fire sprinkler systems 830-834 (directly and/or via intermediary devices such as in-facility communicators), display information representing such parameters on one or more display devices, send control signals to sprinkler components of the fire sprinkler systems 830-834 (directly and/or via intermediary devices), and/or send one or more signals to other computer device(s) (such as in-facility communicator(s), BMS(s), FACP(s), personal computer(s), smartphone(s), pager(s), etc.).

The fire sprinkler systems 830-834 may each include one or more sprinkler components 204 and/or in-facility communicators 610, and may be configured as appropriate for its location and intended use. Thus, each fire sprinkler system 830-834 may be a single zone system or a multi-zone system, and may include a wet pipe sprinkler system or a dry pipe sprinkler system.

Although three fire sprinkler systems 830-834 are illustrated in the embodiment of FIG. 8, more or less fire sprinkler systems may be connected in communication with the monitoring device 402 in other embodiments. Further, while the monitoring device 402 is illustrated as a remote, standalone monitoring device in FIG. 8, the monitoring device 402 (or additional monitoring device(s)) may instead be located on-site with one of the fire sprinkler systems, such as fire sprinkler system 834 (as indicated by the monitoring device shown in phantom in FIG. 8).

The communication network 836 (and the communication networks employed in other embodiments described herein) may include one or more wired and/or wireless networks. For example, the communication network 836 may include one or more wires (e.g., cables) interconnecting the monitoring device 402 with the sprinkler systems 830, 832, 834. Further, the communication network 836 may include a local area network (LAN), a wide area network (WAN) such as, e.g., the Internet, a cellular network, a telephone (e.g., POTS) network, a satellite network, an Infrared network, etc. The communication network 836 may also employ any suitable communication protocol(s) including, for example, TCP/IP (including Modbus TCP/IP), Bluetooth, etc.

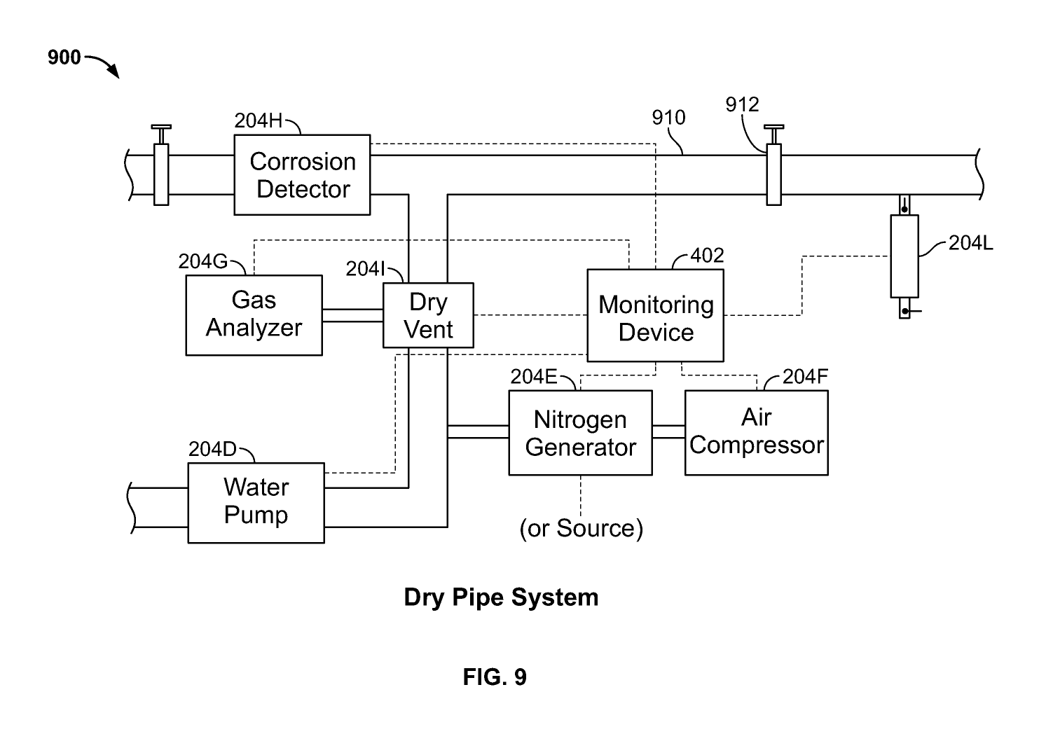

FIG. 9 illustrates one example embodiment of a dry pipe sprinkler system 900 having several sprinkler components 204 of the types described herein with reference to FIG. 2 and/or FIG. 3. As shown in FIG. 9, the sprinkler system 900 includes a piping network 910 and one or more fire sprinklers 912 for dispensing water when the system is actuated (i.e., during testing, once a fire has been detected, etc.). The system 900 further includes a water pump 204D for providing pressurized water, a nitrogen generator 204E for providing purified nitrogen to the piping network 910, and an air compressor 204F for supplying pressurized air to the nitrogen generator 204E and/or the piping network 910. As an alternative to the nitrogen generator 204E, the system 900 may employ another source of purified nitrogen, such as a stored nitrogen system including one more nitrogen cylinders.

The system 900 further includes a dry pipe vent 204I that is coupled to the piping network 910 and adapted to selectively allow gas but not water to escape the piping network 910. The vent 204I is preferably positioned adjacent to the nitrogen generator 204E on a riser of the piping network 910 (e.g., in a riser room), but may be positioned at another location in the piping network 910 (e.g., at an extremity of the piping network 910 relative to the nitrogen generator) if desired.

The system 900 of FIG. 9 also includes a gas analyzer 204G for detecting the level of a gas (such as oxygen) in the piping network 910. Although the gas analyzer 204G is shown coupled to the vent 204I in FIG. 9, the gas analyzer 204G may be coupled directly to the piping network 910 or to another sprinkler component instead, and may be located as desired in the system 900.

Also shown in FIG. 9 is a corrosion detector 204H coupled to the piping network 910 to detect corrosion activity in the system 900, an auxiliary low point drain 204L for collecting and removing relatively small amounts of liquid water from the piping network 910, as well as a monitoring device 402 coupled in one-way or two-way communication (via a wired and/or wireless communication network) with each of the water pump 204D, the nitrogen generator 204E, the air compressor 204F, the vent 204I, the gas analyzer 204G, the corrosion detector 204H, and the auxiliary low point drain 204L. Alternatively, the monitoring device 402 may be replaced by an in-facility communicator 610 (not shown) configured to communicate with on-site and/or off-site monitoring device(s). In that case, the in-facility communicator may be configured to perform the same and/or different functions than the monitoring device(s), as explained herein.

Although only one of each sprinkler component type is illustrated in the example of FIG. 9, it should be understood that more or less (including none) of each component type (or other component types) may be employed in other embodiments.

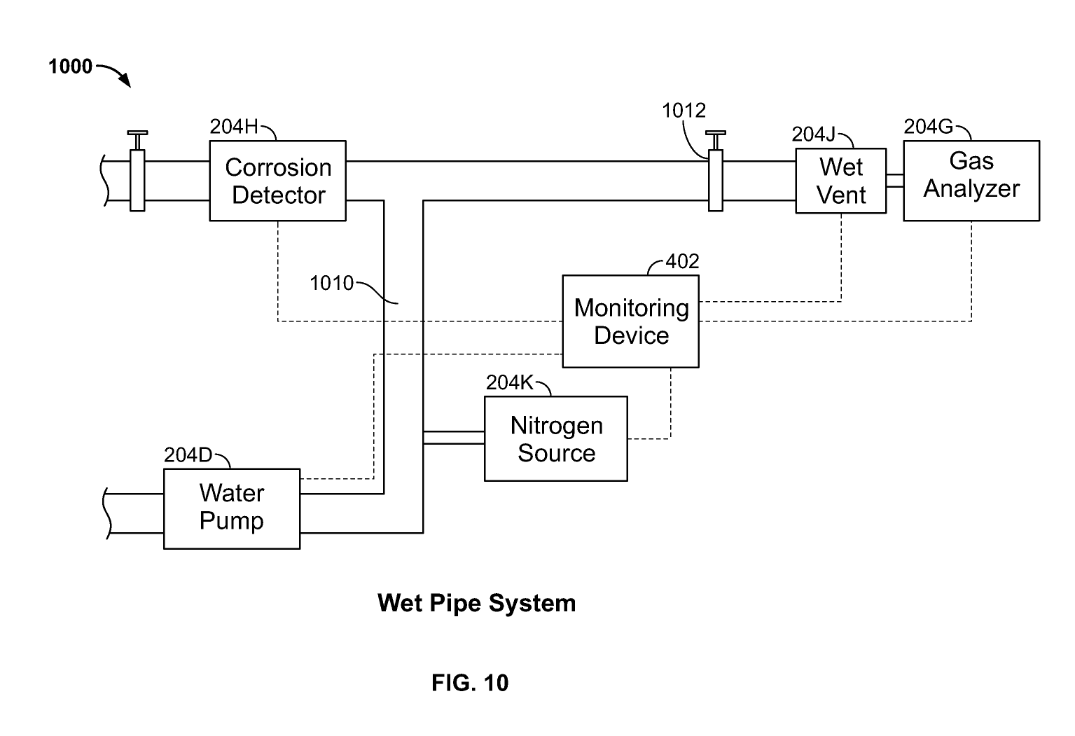

FIG. 10 is similar to FIG. 9, but illustrates one example embodiment of a wet pipe fire sprinkler system 1000 having several sprinkler components 204 of the types described herein with reference to FIG. 2 and/or FIG. 3. The system 1000 includes a piping network 1010 and one or more fire sprinklers 1012 for dispensing water when the system 1000 is actuated. Similar to the dry pipe sprinkler system shown in FIG. 9, the system 1000 of FIG. 10 includes a water pump 204D, a nitrogen source 204K (e.g., a portable or stationary nitrogen generator, a nitrogen storage system, etc.), and a corrosion detector 204H.

The system 1000 further includes a wet pipe vent 204J that is coupled to the piping network 1010 and adapted to allow gas but not water to escape the piping network 1010. The vent 204J is preferably positioned at an extremity of the piping network 1010 relative to the nitrogen source 204K, but may be positioned at another location in the piping network 1010 (e.g., on a riser of the piping network, etc.) if desired.

Similar to the example of FIG. 9, the system 1000 of FIG. 10 includes a gas analyzer 204G that is coupled to the vent 204J, but may instead be coupled to another component or to the piping network 1010 directly and/or positioned at another location in the piping network 1010.

The system 1000 of FIG. 10 further includes a monitoring device 402 coupled in one-way or two-way communication (via a wired and/or wireless communication network) with each of the water pump 204D, the nitrogen source 204K, the vent 204J, the gas analyzer 204G, and the corrosion detector 204H. Alternatively, the monitoring device 402 may be replaced by an in-facility communicator 610 (not shown) configured to communicate with on-site and/or off-site monitoring device(s). In that case, the in-facility communicator may be configured to perform the same and/or different functions than the monitoring device(s), as noted herein.

Although only one of each component type is illustrated in the example of FIG. 10, it should be understood that more or less (including none) of each component type (or other component types) may be employed in other embodiments.

As should be apparent, a wide variety of known fire sprinkler system components can be modified as necessary (i.e., by adding a communication interface and/or suitable detector(s)) for use with the devices, methods and systems disclosed herein. Some examples include the nitrogen generators, nitrogen storage systems, air compressors, gas analyzers, dry pipe vents, wet pipe vents, corrosion detectors and water pumps disclosed in U.S. application Ser. Nos. 12/210,555, 12/606,287, 12/615,738 (now U.S. Pat. No. 8,636,023), Ser. Nos. 13/048,596, 13/197,925, 61/357,297, 61/383,396, 61/544,462, 61/554,785, 61/789,131, 61/820,439, 61/833,572 and 61/992,590, and PCT Application Nos. PCT/US09/56000, PCT/US10/54108, PCT/US11/40003, PCT/US11/51907, PCT/US12/58567, PCT/US12/62660, PCT/US13/43707, PCT/US14/30631 and PCT/US14/37144. The entire disclosures of the aforementioned applications are incorporated herein by reference.

As noted above, the sprinkler component 204 shown in FIGS. 2 and 3 may be a nitrogen generator. In that case, the detector(s) 206 (if employed) may include a current sensor, an oxygen sensor, a temperature sensor (e.g., a thermocouple), a pressure transducer, an electronic hour meter, a flow meter, a geographic location detector and/or a filter manometer. The oxygen sensor may be, e.g., a zirconium dioxide oxygen sensor.

The nitrogen generator may be of any suitable type including permeable membrane generators, pressure-swing adsorption (PSA) generators, etc.

Additionally, the nitrogen generator may be configured to output via the communication interface 208 signal(s) indicative of, for example, a presence of power (e.g., detected with a current sensor on a power supply of the nitrogen generator), an output gas purity (e.g., detected with a zirconium dioxide sensor on the output side of the nitrogen generator), a generation mode status of the nitrogen generator, a nitrogen generator cumulative runtime (e.g., detected with an hour meter), a nitrogen delivery line pressure (e.g., detected with a pressure transducer on the output side of the nitrogen generator), a compressed air delivery pressure (e.g., detected with a pressure transducer on the input side of the nitrogen generator), input, output and bypass valve positions in a valve bypass assembly (e.g., detected with electronic valve position sensor(s)), a flow control valve position (e.g., detected as a percentage of full port flow), a nitrogen gas flow (e.g., detected with a flow meter installed on the output side of the nitrogen generator), a temperature of the inlet air to the nitrogen generator (e.g., detected with a thermocouple installed on the input side of the nitrogen generator), a temperature inside the nitrogen generator enclosure (e.g., detected with a thermocouple mounted inside the nitrogen generator enclosure), the geographic location of the nitrogen generator (e.g., detected with a GPS receiver or as programmed and/or stored in memory), data indicating the component type and/or ID of the nitrogen generator, etc.

Further, the nitrogen generator may have field-adjustable setting(s) including, for example, a nitrogen generation rate, a nitrogen purity level, the state of electronically actuatable component(s), the position of a flow control valve downstream of a membrane for establishing a desired flow of nitrogen gas by increasing and/or decreasing a residence time of a compressed air stream through the membrane, a pressure setting of an input regulator to establish an input pressure to the nitrogen membrane, a pressure setting of an output regulator to establish an outlet pressure of the nitrogen gas, the open and/or closed state of an input valve, an output valve and/or a bypass valve in a bypass assembly, and a nitrogen generation mode for solenoid valve(s) to initiate and/or cease generation of nitrogen gas. Therefore, the nitrogen generator may be configured to receive control signal(s) via the communication interface 208 and adjust the field-adjustable setting(s)—or adjust its operation in another manner—in response to the control signal(s). The nitrogen generator may be stationary or portable (e.g., on wheels).

The nitrogen generator is adapted to provide a source of purified nitrogen (e.g., greater than the concentration of nitrogen in ambient air, typically in the range of 80% to 99.9% nitrogen, and preferably at least 85%, 90%, 95% or 98% nitrogen) to inhibit oxygen corrosion in a piping network.

As noted above, the sprinkler component 204 shown in FIGS. 2 and 3 may be an air compressor. In that case, the detector(s) 206 (if employed) may include a pressure transducer (e.g., an electronic pressure switch), a low oil switch, a current sensor (e.g., an ammeter), an hour meter, a conductance probe, a temperature sensor (e.g., a thermocouple), a geographic location detector, and/or a filter manometer.

The air compressor may be of any suitable type including an air compressor driven by an electrical and/or combustion powered machine, and may include one or more of a compressor, an air receiver tank, an after-cooler, and an automatic tank drain.

Additionally, the air compressor may be configured to output via the communication interface 208 signal(s) indicative of a presence of power (e.g., detected with a current sensor located on an incoming power supply of the air compressor), an amperage draw of a compressor motor (e.g., detected with a current sensor such as an ammeter located on the incoming power supply), a compressor running status (e.g., detected with a current sensor located on the incoming power supply), a compressor delivery line pressure (e.g., detected with a pressure transducer located on the air receiver tank), a cumulative compressor runtime (e.g., detected with an hour meter connected to the load side of the power supply), a presence of water in the air receiver tank (e.g., detected with a conductance probe located on or in the air receiver tank), a temperature of delivery air (e.g., detected with a thermocouple located on the air receiver tank), a pressure drop across filter elements (e.g., detected with a manometer located on an air filter housing), a low oil condition (e.g., detected with a low oil switch mounted on an oil reservoir of the air compressor), the geographic location of the air compressor, a component type and/or ID of the air compressor, etc.

The sprinkler component 204 shown in FIGS. 2 and 3 may also be a gas analyzer of any suitable type including, e.g., an oxygen analyzer, a nitrogen analyzer, etc. In that case, the detector(s) 206 (if employed) may include one or more sensors capable of detecting the concentration(s) of one or more chemicals, such as oxygen, nitrogen, argon, etc. In particular, the detector(s) 206 may include a zirconium oxide sensor. The detector(s) 206 may also include a geographic location detector (e.g., a GPS receiver).

Further, the gas analyzer may be portable (e.g., hand-held) or stationary (e.g., intended to remain secured to a piping network or sprinkler component), may be a single-stream or multi-stream analyzer, etc.

Additionally, the gas analyzer may be configured to output via the communication interface 208 signal(s) indicative of a level of gas (such as oxygen or nitrogen) in a sample gas stream (e.g., detected with a zirconium dioxide oxygen sensor), a pressure in a zone (e.g., detected with a pressure transducer), a temperature in a zone (e.g., detected with a thermocouple), a cumulative time of sensor operation, the status of a heater element (if applicable), a fault in the gas analyzer, the geographic location of the gas analyzer, a component type and/or ID of the gas analyzer, etc.

Further, the gas analyzer may have field-adjustable setting(s) including, for example, the open/closed status of a feed solenoid valve, the position of valve(s) in a manifold for sampling multiple gas streams, etc.

The gas analyzer may also be capable of receiving multiple gas streams and sampling each gas stream via an automated or manual valve manifold. Further, the gas analyzer may be configured to turn on/off one or more gas streams to minimize venting of gas from the piping network of a dry pipe sprinkler system (if applicable), and thus minimize the need to inject more gas (e.g., including oxygen) into the piping network.

The sprinkler component 204 shown in FIGS. 2 and 3 may be a water pump of any suitable type for supplying pressurized water to the piping network of a fire sprinkler system. In that case, the detector(s) 206 (if employed) may include pressure detectors, flow sensors, a geographic location detector, etc. The water pump may be configured to output via the communication interface 208 signal(s) indicative of the detected parameters and/or the geographic location of the water pump, a component type and/or ID of the water pump, etc.

The sprinkler component 204 shown in FIGS. 2 and 3 may also be an auxiliary low point drain (sometimes referred to as a “drum drip”) of any suitable type for collecting and draining relatively small amounts of water (e.g., condensation from compressed air, residual water following hydrostatic testing, periodic drip testing, an actual trip event, etc.) from the piping network of a water-based fire sprinkler system. As noted above, a typical auxiliary low point drain for a dry pipe system includes a chamber (e.g., formed of a twelve inch length of two inch diameter pipe) for receiving water from the piping network of the fire sprinkler system, an upper valve for controlling passage of water from the piping network to an interior of the chamber, and a lower valve for controlling passage of water from the interior of the chamber to an external environment (e.g., external to the fire sprinkler system and the auxiliary low point drain). In that case, the detector(s) 206 (if employed) may include one or more of a liquid detector for detecting a presence or level of water in the interior of the chamber, valve position detector(s) for detecting whether the upper valve and/or the lower valve (or other valve(s), as applicable) is open or closed, a temperature detector for detecting a temperature internal or external to the chamber, a geographic location detector (e.g., a GPS receiver), a pressure detector for detecting a pressure internal or external to the chamber, etc. The liquid detector, if employed, may include a conductivity detector, a sonar detector, an optical detector, an ionization detector, etc.

The auxiliary low point drain may include one or more visual and/or audible indicators, such as indicator lights, audible alarms, buzzers, etc. If so, the drain may be configured to activate the visual and/or audible indicator(s) in response to detecting parameter(s). For example, the drain may be configured to activate the visual and/or audible indicator(s) in response to detecting a presence or level of water in the interior of the chamber, in response to determining its valve(s) have not been cycled within a defined time period (e.g., a defined duration of time since the valve(s) were last cycled), in response to detecting an ambient temperature below a threshold temperature (such as forty, thirty-five or thirty-two degrees Fahrenheit), etc.

The auxiliary low point drain may include the communication interface 208 described herein with reference to FIGS. 2 and 3 for sending data to and/or receiving data from a remote device via a wired and/or wireless communication network. For example, the drain may be configured to send data indicative of one or more detected parameters to a monitoring device via the communication interface. In some embodiments, the auxiliary low point drain includes relay(s) coupled to the communication interface for providing signal(s) representing the status of indicator(s), valve position(s), presence or level of water in the chamber, temperature, time since the auxiliary drain was last cycled, etc. Each relay may also (or instead) be associated with a visual or audible indicator for activating and/or providing a signal representing the indicator status. Additionally, or alternatively, the drain may be configured to send data identifying the auxiliary low point drain by type and/or ID via the communication interface. The drain may also (or instead) include analog output(s) for providing analog signal(s) representing any of the various parameter(s) described herein, including a pressure within the chamber, a temperature internal or external to the chamber, etc.

Further, the auxiliary low point drain may include a user interface, such as a keypad, touchpad, keyboard, etc. by which a user can input the location of the drain (e.g., by entering a zip code corresponding to the drain's location). In that event, the drain is preferable configured to store the entered location.

If the drain is configured to store data representing its location (e.g., as input by a user, as stored with a programming tool at the factory or in the field, as detected by a geographic location detector, etc.), the drain can be configured to use the stored location data to access weather data corresponding to its location (e.g., via an online weather forecast database, subscription service, etc.). The drain may also be configured to cycle its valve(s) (e.g., sequentially, if the drain includes multiple valves such as the upper and lower valves described herein) to drain water from the interior of the chamber if the accessed weather data is forecasting a temperature below a threshold temperature at the drain's location. Additionally, or alternatively, the drain may be configured to send data representing its location to a monitoring device via the communication interface.

In some embodiments, the auxiliary low point drain is configured to receive control signal(s) from a monitoring device via the communication interface. In these embodiments, the drain may be configured to cycle its valve(s) (e.g., sequentially or otherwise) to drain water from the interior of the chamber, and/or activate visual and/or audible indicator(s), in response to receiving the control signal(s) from the monitoring device.

The drain may also include one or more visual displays (e.g., analog and/or digital displays) for displaying detected parameter(s) such as ambient temperature, a pressure within the chamber, etc.

As should be apparent, the auxiliary low point drain may include processor(s) and non-transitory memory storing computer-executable programming instructions for implementing any or all of the various functionality described herein.

The sprinkler component 204 shown in FIGS. 2 and 3 may also take the form of a corrosion detector of any suitable type including, for example, an in-line corrosion detector (which may form part of a sprinkler system's piping network), a corrosion monitoring station having coupons for detecting corrosion activity, etc. In that case, the detector(s) 206 (if employed) may include a pressure transducer (e.g., a pressure switch) to detect a pressure (including a pressure change) in a zone (e.g., a detection chamber) of the corrosion detector, a temperature sensor (e.g., a thermocouple) to detect a temperature on and/or in the corrosion detector (e.g., corresponding to a temperature within the piping network of a fire sprinkler system), an induced electrical current detector to detect an electrical resistance (including a change in resistance) of a coupon, pipe wall, etc., a timer for detecting the corrosion detector's cumulative time in service, a geographic location of the corrosion detector, etc. Additionally, the corrosion detector may be configured to output via the communication interface 208 signal(s) indicative of the detected parameter(s) and/or the geographic location of the corrosion detector (e.g., as stored in memory), the component type and/or ID of the corrosion detector, etc.

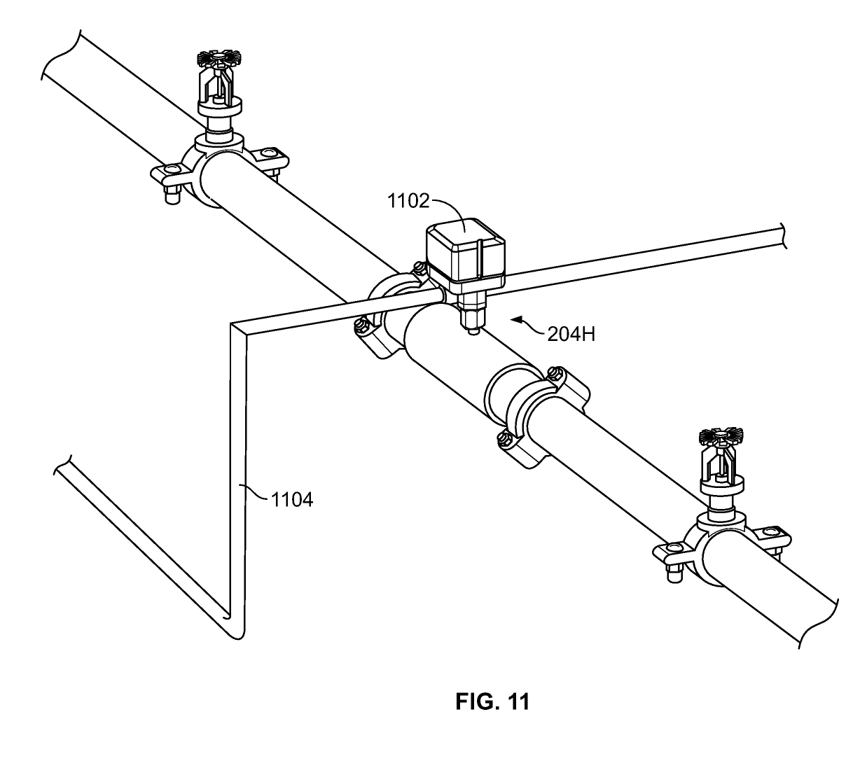

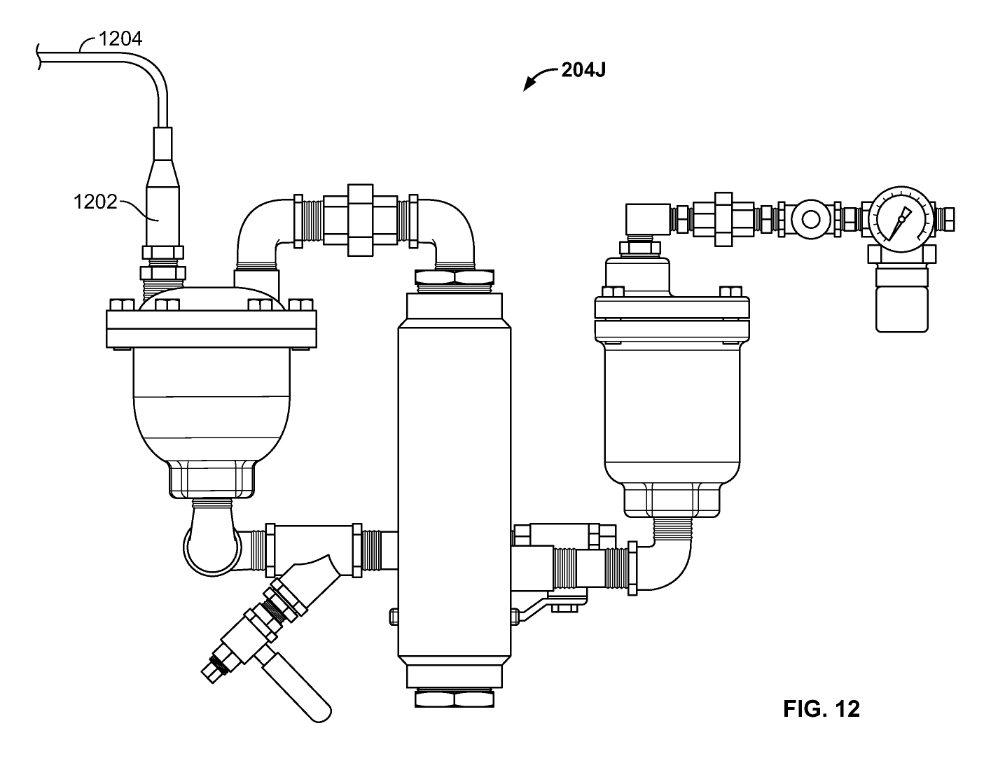

FIG. 11 illustrates one example of an in-line corrosion detector 204H connected in series with and forming a portion of a sprinkler piping network. The corrosion detector 204H may be configured in any suitable manner, including as described in PCT Application No. PCT/US14/37144. In the particular example shown in FIG. 11, the corrosion detector 204H includes a pressure switch (not shown) for sensing pressure changes in a pressure chamber of the corrosion detector 204H. The pressure switch is positioned within a housing 1102. As shown in FIG. 11, the housing 1102 may be coupled to conduit 1104 for providing a hard-wired connection between the pressure switch and other devices or components (including monitoring devices, in-facility communicators, indicators, switches, power sources, etc.).

In one preferred implementation, the corrosion detector 204H includes a thinly milled (e.g., 25/1000 of an inch) section of pipe and another section of pipe welded over the thin wall section to create a pressure chamber. The pressure switch can detect pressure changes in the pressure chamber, and may include a double pole single throw (DPST) relay. Once corrosion has compromised (i.e. breached) the thin walled section of pipe, the pressure switch detects a pressure change in the pressure chamber and changes the state of its relay contacts (e.g., from a normal position to an alarm position).

The sprinkler component 204 shown in FIGS. 2 and 3 may also take the form of a vent of any suitable type for removing gas but not liquid from the piping network of a fire sprinkler system, including a wet pipe vent, a dry pipe vent, etc. In that case, the detector(s) 206 (if employed) may include a pressure transducer (e.g., a pressure switch) to indicate a pressure at or in the vent (which may correspond to a pressure in the piping network), a temperature sensor (e.g., a thermocouple) to indicate a temperature at or in the vent (which may correspond to a temperature internal or external to the piping network), a valve position detector, a flow meter to measure a volume of gas being vented, an oxygen sensor to measure the oxygen concentration of vented gas, a conductance probe to detect a presence of water in the vent, a geographic location detector, etc.

Additionally, the vent may be configured to output via the communication interface 208 signal(s) indicative of, for example, a presence of power (e.g., detected with a current sensor coupled to a power supply of the vent), a pressure in a vent zone (e.g., detected with a pressure transducer such as a pressure switch), a temperature in a vent zone (e.g., detected with a thermocouple), a status of a vent valve as open and/or closed (e.g., detected with an electrical position feedback switch), a purity of gas being vented (e.g., detected with a zirconium dioxide oxygen sensor), a volume of gas being vented (e.g., detected with an electronic flow meter), a cumulative venting time (e.g., detected with a timer triggered by the valve position switch and/or flow value from the flow meter), a presence of water in the vent (e.g., detected with a conductance probe), a geographic location of the vent (e.g., as detected by a GPS receiver, as input by a user and/or stored in memory, etc.), a type and/or ID of the vent, etc.

Further, the vent may have field-adjustable setting(s) including, for example, the open/closed position of one or more vent valves, and may be configured to adjust its field-adjustable setting(s) in response to receiving control signal(s) as described herein.

FIG. 12 illustrates one particular example of a wet pipe vent 204J according to the present disclosure. The wet pipe vent 204J is similar to those disclosed in U.S. Pat. No. 8,636,023 referenced above, and includes a pressure detector 1202 (such as a pressure switch, etc.). In the example of FIG. 12, the pressure detector 1202 is coupled to the output port of a float valve, and includes a wire 1204 for outputting signal(s) indicative of the detected pressure. These signal(s) may indicate a particular pressure level, whether the detected pressure is above or below a pressure threshold, etc. The wire 1204 may be connected to other devices or components (including monitoring devices, in-facility communicators, indicators, switches, power sources, etc.). Alternatively, the wet pipe vent 204J may be configured to send signal(s) wirelessly to a monitoring device 402, an in-facility communicator 610, and/or other device(s).

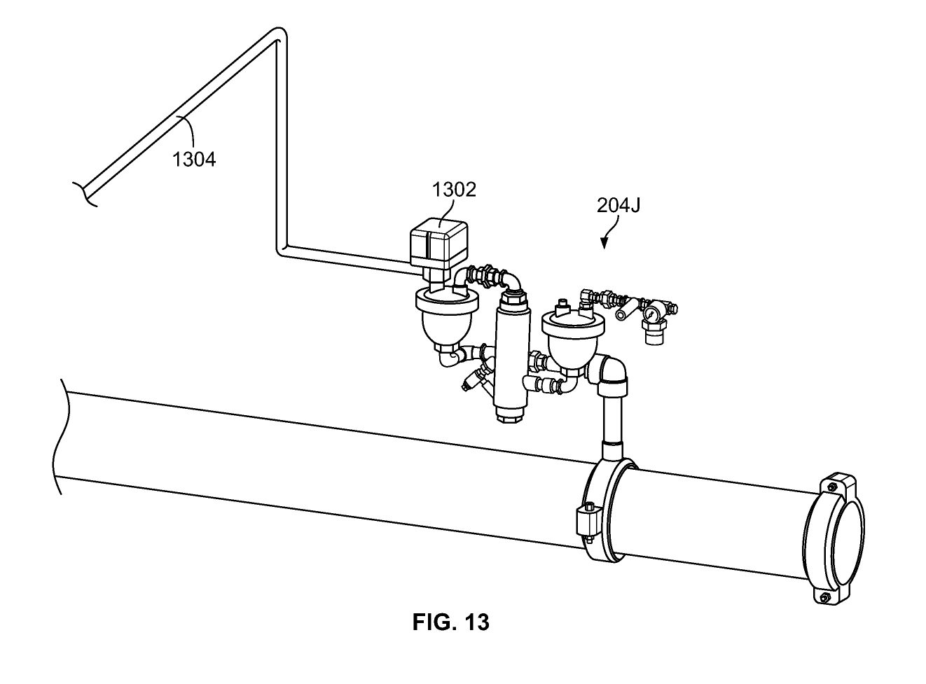

FIG. 13 illustrates a wet pipe vent 204J similar to the vent shown in FIG. 12. In the particular example shown in FIG. 13, the vent 204J includes a pressure switch (not shown) for sensing pressure changes in the piping network on the input side of the vent 204J (e.g., on the system side of the primary float valve). The pressure switch is positioned within a housing 1302. As shown in FIG. 13, the housing 1302 may be coupled to conduit 1304 for providing a hard-wired connection between the pressure switch and other devices or components (including monitoring devices, in-facility communicators, indicators, switches, power sources, etc.). Alternatively (or additionally), wireless connections may be employed.

In the example of FIG. 13, the pressure switch includes a double pole single throw (DPST) relay which outputs a high or low voltage based on whether the detected pressure exceeds an adjustable pressure threshold. As an example, the adjustable pressure threshold may be set at 10 psig. This would allow the vent to sense when the piping network has been drained (depressurized) or filled (pressurized). Alternatively, the pressure threshold may be set at 25 psig. This would allow the vent to sense when the piping network has been pressurized above or depressurized below 25 psig, e.g., to verify the piping network has been pressurized with nitrogen (e.g., above 25 psig) one or more (and preferably three) times as part of an inerting process, prior to filling the piping network with pressurized water.

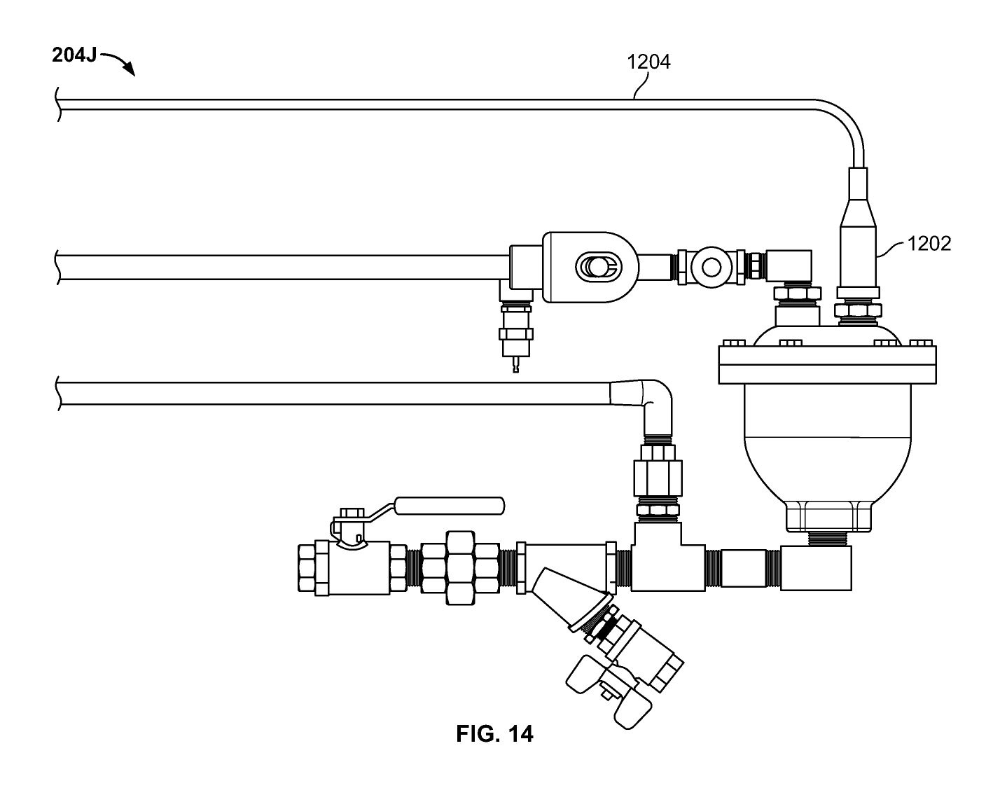

FIG. 14 illustrates another example of a wet pipe vent 204J according to the present disclosure. The wet pipe vent 204J of FIG. 14 is similar to those disclosed in the '733 and '707 applications referenced above, and includes the pressure detector 1202 and the wire 1204 described with reference to the example of FIG. 12. As in the example of FIG. 12, the wire 1204 shown in FIG. 14 may be connected to a monitoring device 402, an in-facility communicator 610 and/or other device(s). Alternatively, the wet pipe vent 204J may be configured to send signal(s) wirelessly to a monitoring device 402, an in-facility communicator 610, and/or other devices.

Similarly, the wet pipe vent 204J shown in FIG. 14 may be configured like the riser vents shown and/or described in U.S. Application No. 61/992,590, with a pressure detector 1202 for outputting signal(s) indicative of the pressure on the input side of the vent 204J (e.g., on the system side of the primary float valve).

The wet pipe vents 204J shown in FIGS. 12, 13 and 14 and/or described herein may be used to monitor pressures in wet pipe fire sprinkler systems. For example, the piping networks of some wet pipe systems are normally filled with water at a pressure of at least 60 psig. Thus, if the pressure detector 1202 detects a pressure below 60 psig, this may indicate the piping network contains a leak, the wet pipe sprinkler system has been drained for service or testing, etc. Accordingly, appropriate action may be needed, for example, to fix a leakage or ensure the piping network is substantially filled with an inert gas such as nitrogen before water is reintroduced to the piping network.

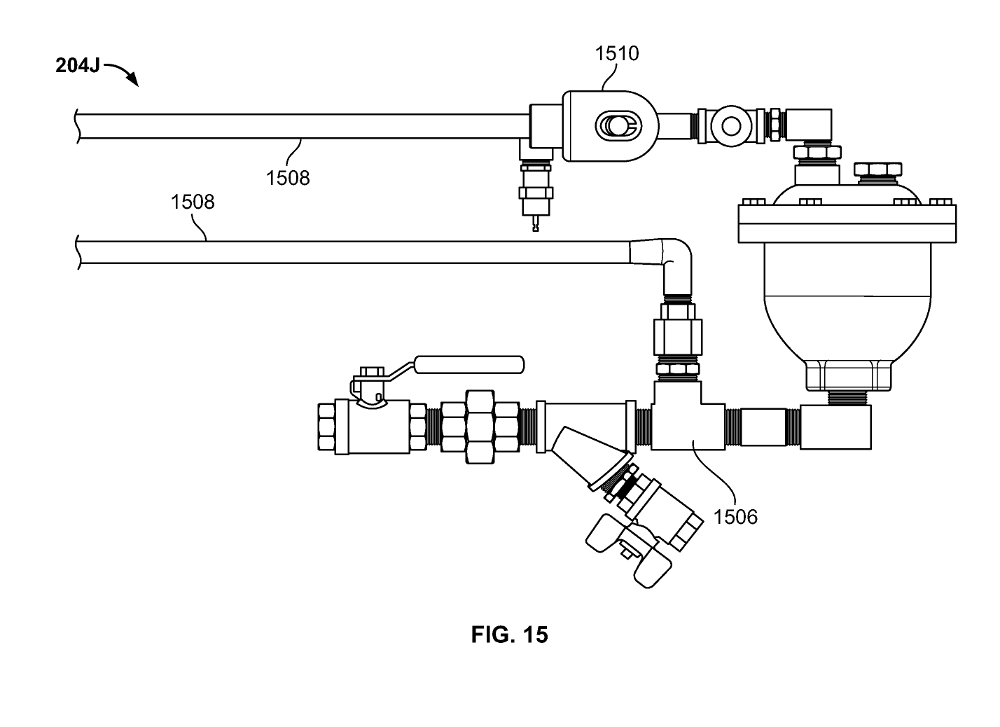

FIG. 15 illustrates a wet pipe vent 204J similar to the vent of FIG. 14, but without the pressure detector 1202. The vent of FIG. 15 includes a conductance probe 1506 for opening and closing a solenoid valve 1510 based on whether the presence of water is detected at the conductance probe. The conductance probe includes a wire (within a conduit 1508) that is coupled to the solenoid valve 1510, and which may also be coupled to a monitoring device 402, an in-facility communicator 610, indicator(s) and/or other device(s) for providing signal(s) indicative of the presence or absence of water in the vent 204J.

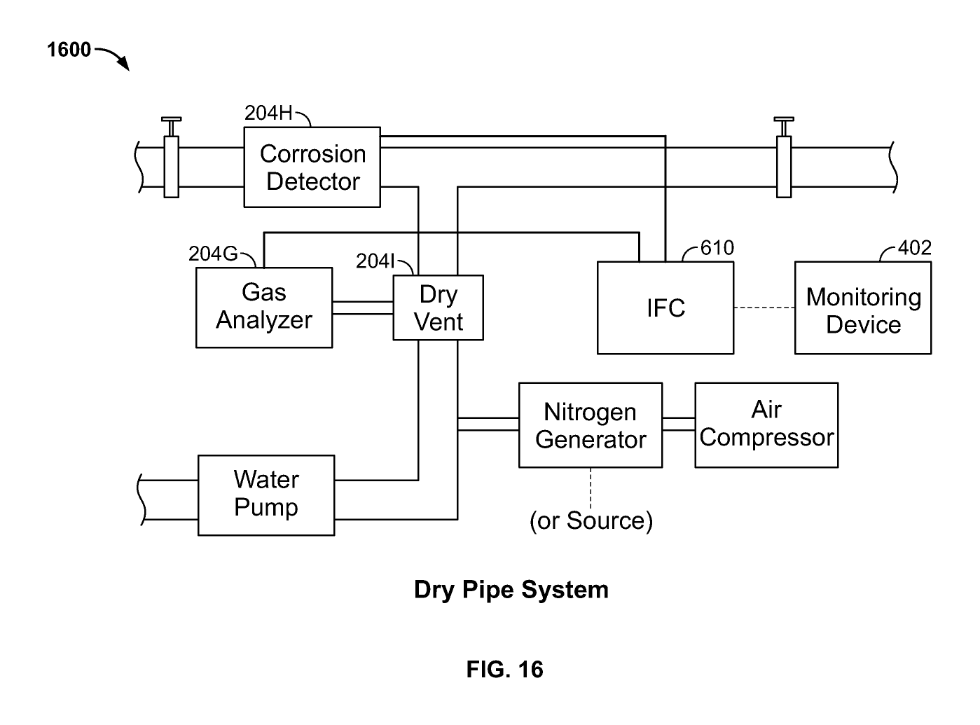

FIG. 16 illustrates a dry pipe sprinkler system 1600 according to another example embodiment. As shown in FIG. 16, the system 1600 includes a corrosion detector 204H, a gas analyzer 204G, and other sprinkler components. The corrosion detector 204H is preferably an in-line corrosion detector of the type described above and shown in FIG. 11. The gas analyzer 204G is preferably one of the various gas analyzers described herein. In the particular example shown in FIG. 16, the gas analyzer 204G is coupled to a dry pipe vent 204I.

The dry pipe system 1600 further includes an in-facility communicator 610 (which may be a stand-alone device) and a monitoring device 402 (which may include a computer server). The in-facility communicator 610 is configured to receive signals from corrosion detector(s) 204H and gas analyzer(s) 204G (and possibly other sprinkler components) indicative of detected parameters. The in-facility communicator 610 is also configured to send signals indicative of the detected parameters to the monitoring device 402. The monitoring device 402 may be configured to log data regarding the detected parameters (e.g., in a computer server), and send signals (including email, text and/or voice alerts, etc.) to other computer device(s) in response to receiving signals indicative of certain (or any) detected parameter(s). The monitoring device 402 may also be configured to permit authorized users to remotely access data stored by the monitoring device (e.g., via the Internet). In one preferred implementation, the corrosion detector(s) 204H and gas analyzer(s) 204G are hard wired to the in-facility communicator 610, and the in-facility communicator 610 communicates wirelessly with off-site monitoring device(s) 402 (e.g., via a cellular network).

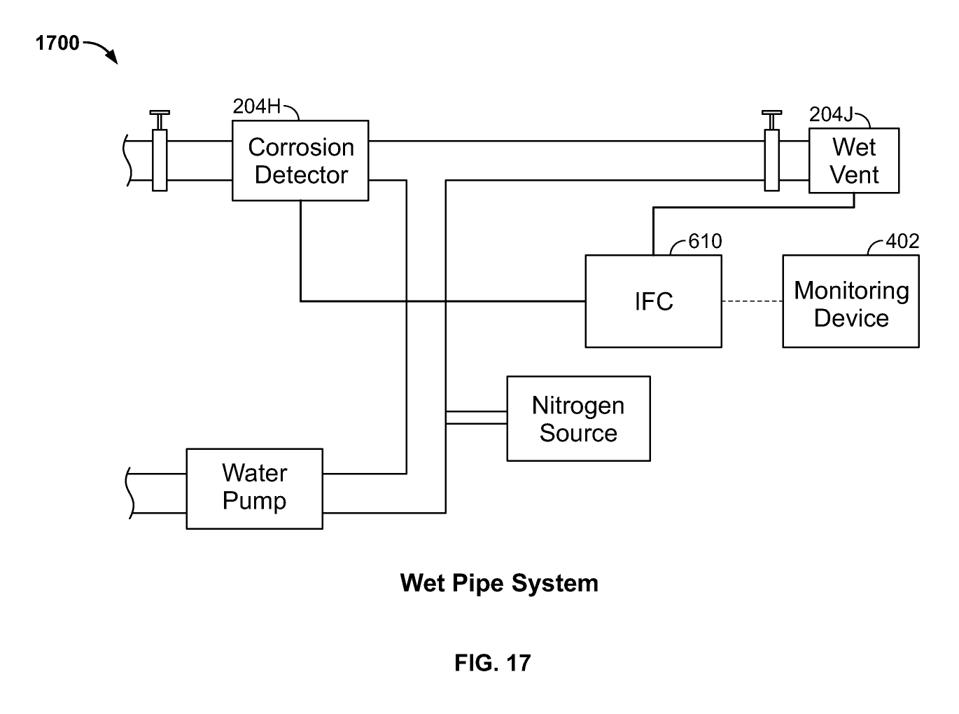

FIG. 17 illustrates a wet pipe sprinkler system 1700 according to another example embodiment. As shown in FIG. 17, the system 1700 includes a corrosion detector 204H, a wet pipe vent 204J, and other sprinkler components. The corrosion detector 204H is preferably an in-line corrosion detector of the type described above and shown in FIG. 11. The wet pipe vent 204J is preferably one of the various wet pipe vents described herein.

The wet pipe system 1700 further includes an in-facility communicator 610 (which may be a stand-alone device) and a monitoring device 402 (which may include a computer server). The in-facility communicator 610 is configured to receive signals from corrosion detector(s) 204H and wet pipe vent(s) 204J (and possibly other sprinkler components) indicative of detected parameters. The in-facility communicator 610 is also configured to send signals indicative of the detected parameters to the monitoring device 402. The monitoring device 402 may be configured to log data regarding the detected parameters (e.g., in a computer server), and send signals (including email, text and/or voice alerts, etc.) to other computer device(s) in response to receiving signals indicative of certain (or any) detected parameter(s). The monitoring device may also be configured to permit authorized users to remotely access data stored by the monitoring device (e.g., via the Internet). In one preferred implementation, the corrosion detector(s) 204H and wet pipe vents 204J are hard wired to the in-facility communicator 610, and the in-facility communicator 610 communicates wirelessly with off-site monitoring device(s) 402 (e.g., via a cellular network).

The monitoring device 402 shown in FIG. 16 and the monitoring device 402 shown in FIG. 17 may be the same device. In other words, the same monitoring device 402 may be coupled to the in-facility communicator 610 shown in FIG. 16 and to the in-facility communicator 610 shown in FIG. 17. In this manner, the monitoring device 402 can monitor the operating condition and/or status of the dry pipe system 1600 shown in FIG. 16 and the wet pipe system 1700 shown in FIG. 17, as well as numerous other fire sprinkler systems, if desired.

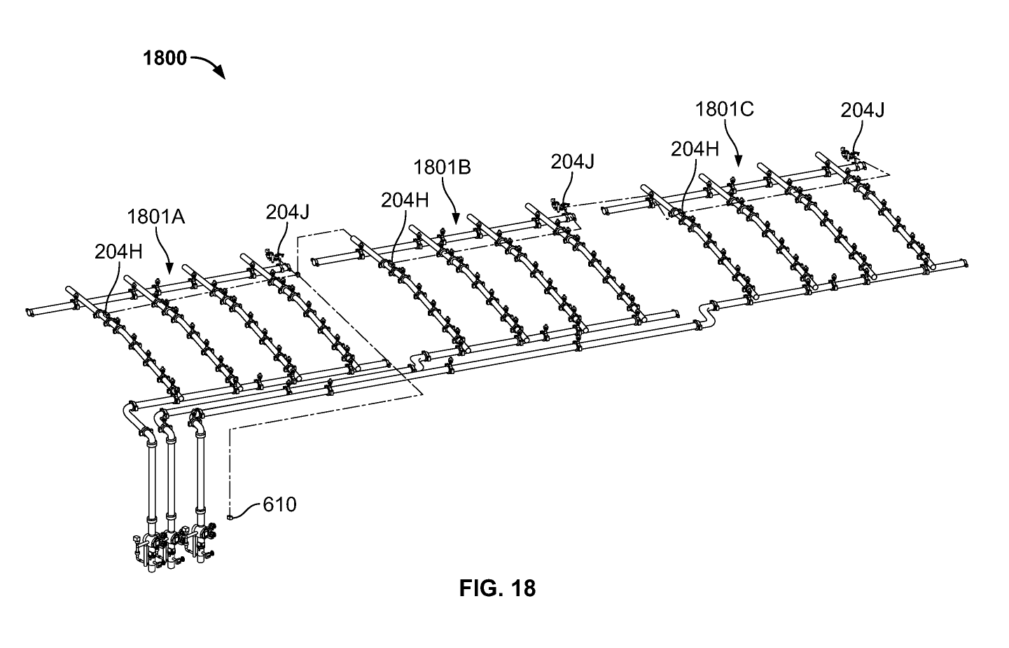

While not shown in FIGS. 16 and 17, each system 1600, 1700 may include additional sprinkler zones. For example, FIG. 18 illustrates a wet pipe sprinkler system 1800 having multiple sprinkler zones 1801A, 1801B, 1801C. In this example, each sprinkler zone 1801A, 1801B, 1801C includes an in-line corrosion detector 204H and a wet pipe vent 204J. Further, the several corrosion detectors 204H and wet pipe vents 204J are hard-wired to an in-facility communicator 610 that is configured to communicate wirelessly with one or more on-site and/or off-site monitoring devices.

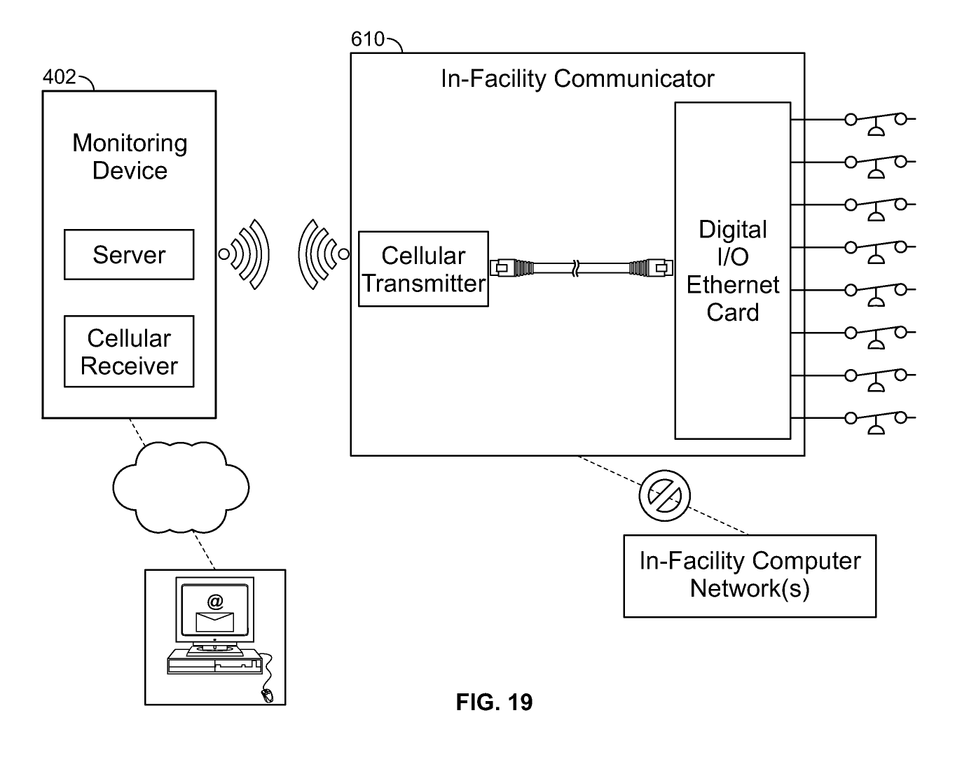

FIG. 19 illustrates one example implementation of an in-facility communicator 610. As shown in FIG. 19, the in-facility communicator 610 may include a digital input/output Ethernet card and a cellular transmitter. The Ethernet card includes multiple inputs for sensing multiple digital input signals from sprinkler components 204. In the particular example shown in FIG. 19, the Ethernet card includes eight digital inputs for sensing digital signals from up to eight sprinkler components 204 (e.g., coupled to the inputs via relays, as shown in FIG. 19). The Ethernet card is adapted to sense the digital input signals and transmit these signals using suitable protocol(s) (e.g., Modbus TCP/IP) to the cellular transmitter (e.g., via a twisted pair cable such as a category 5 cable). The transmitted signals preferably identify the particular sprinkler component 204 that detected a given parameter (e.g., by Ethernet card input number, by location, type and/or ID of the sprinkler component, etc.).

The cellular transmitter may include, for example, a 3G or 4G cellular transmitter for transmitting the signals received from the Ethernet card to a monitoring device 402 over a cellular network, as illustrated in FIG. 19. The cellular transmitter may transmit signals to the monitoring device 402 using any suitable protocol(s). In one preferred embodiment, the cellular transmitter employs the same communication protocol as the Ethernet card (e.g., Modbus TCP/IP). Alternatively, other communication networks and/or protocols may be employed.

The monitoring device 402 may include a cellular receiver for receiving signals from the in-facility communicator 610, and a computer server for storing data relating to detected parameters, as shown in FIG. 19. The monitoring device 402 may be located on-site or off-site relative to the in-facility communicator 610 and the sprinkler components 204 coupled to inputs of the Ethernet card.

While only one Ethernet card, in-facility communicator 610 and monitoring device 402 are shown in FIG. 19, it should be understood the in-facility communicator 610 may include multiple Ethernet cards, multiple in-facility communicators 610 may communicate with the same monitoring device 402, and any particular in-facility communicator 610 may be configured to communicate with multiple on-site and/or off-site monitoring devices 402.

As shown in FIG. 19, the in-facility communicator 610 may be configured to communicate with the monitoring device 402 without using in-facility computer network(s), such as company intranets, local area networks (LANs), broadband connections, building management systems, etc. As a result, it may be more difficult or impossible to hack into the in-facility computer network(s) via the in-facility communicator 610. Alternatively, the in-facility communicator 610 may communicate with the monitoring device 402 using one or more of the in-facility computer networks, preferably in conjunction with other computer security measures. Likewise, the various other sprinkler components, monitoring devices and in-facility communicators described herein may communicate with one another (if and as desired) with or without using or sharing in-facility communication networks, including local area networks (LANs), intranets, email systems, e-commerce systems, etc.

In one preferred implementation, a wet pipe sprinkler system is monitored using several in-line corrosion detectors 204H of the type shown in FIG. 11, and several wet pipe vents 204J of the types shown in FIGS. 12 and 13. Each corrosion detector 204H and wet pipe vent 204J includes a pressure switch having a double pole single throw (DPST) relay. One set of relay contacts from each device is hard wired to a dedicated input on the Ethernet card shown in FIG. 19. For example, a first set of relay contacts from a corrosion detector 204H may be wired to the first input of the Ethernet card. Therefore, when the signal at the first input of the Ethernet card changes from low to high (or vice versa), this indicates corrosion has compromised the thin wall section of the corrosion detector.

The second set of relay contacts from each corrosion detector 204H may be wired to a momentary illuminated switch. When pressed, the switch will illuminate if the relay contacts are in the normal position, indicating the thin wall section has not been compromised. Conversely, the switch will not illuminate when pressed if the relay contacts are in the alarm position, indicating the thin wall section is breached. In this manner, a user can check the status of a corrosion detector 204H by pressing its momentary switch.

Similarly, the first set of relay contacts from a wet pipe vent 204J may be wired to the second input of the Ethernet card. Therefore, when the signal at the second input of the Ethernet card changes from low to high (or vice versa), this indicates a pressure in the wet pipe vent 204J has dropped below (or increased above) a threshold level, which may indicate the piping network has been drained (or filled), the piping network is in the depressurizing “purge” stage (or the pressurized “fill” stage) of a nitrogen inerting process, etc.

The computer server shown in FIG. 19 may include one or more processors and non-transitory computer-readable media storing computer-executable instructions for controlling operation of the computer server. For example, the computer server may be configured to identify the status of each corrosion detector 204H and wet pipe vent 204J coupled to an input of the Ethernet card. Additionally, the computer server may include and maintain a relational database that stores data corresponding to each received signal with an alphanumeric identifier representing, e.g., a building number, sprinkler component type, sprinkler zone number, etc.

Upon receiving a particular (or any) signal from the in-facility communicator 610, the computer server may send an email (and/or other) notification to a particular user. The user email address(es) (and/or other contact information such as telephone numbers, etc.) may be stored in the computer server (e.g., in the relational database). Further, the email address (and/or other contact information) used for any given notification may depend on the building number, sprinkler component type, sprinkler zone number, or other identifier corresponding to the received signal.

In one preferred embodiment, the computer server creates a job ticket for each signal received from the in-facility communicator 610. The computer server will then access the relational database to identify a user email address corresponding to the received signal, and notify the user via email that a particular signal was received. The user can then log into the computer server remotely (e.g., via the Internet) using suitable credentials to access the job ticket, close the job ticket (if appropriate) and/or save data concerning the job ticket to the relational database. The user may also be permitted to check the status of other sprinkler components 204 (e.g., for which the user has permissions) and review historical data and job tickets for such components. Preferably, all signals and data received by the monitoring device 402 are stored in the relational database for subsequent access by authorized users.

The foregoing description of embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of monitoring a water-based fire sprinkler system, the water-based fire sprinkler system including a piping network and one or more sprinkler components, the method comprising:
receiving one or more signals from the one or more sprinkler components, the one or more signals indicative of one or more parameters of the water-based fire sprinkler system; and
displaying information representing the one or more parameters on a computer device having a display, sending one or more control signals to one or more of the sprinkler components, and/or sending one or more signals to another computer device.

2-72. (canceled)
